(19) United States
(12) Patent Application Publication
(10) Pub. No.: US 2017/0346426 A1
(43) Pub. Date: Nov. 30, 2017

(54) APPARATUS AND METHOD TO DETECT STALL CONDITION OF A STEPPER MOTOR

(71) Applicant: Microsemi SoC Corporation, San Jose, CA (US)

(72) Inventor: Prakash Reddy, Hyderabad (IN)

(73) Assignee: Microsemi SoC Corporation, San Jose, CA (US)

(21) Appl. No.: 15/582,463

(22) Filed: Apr. 28, 2017

(30) Foreign Application Priority Data
May 30, 2016 (IN) 201621018528

(51) Int. Cl. H02P 8/38; H02P 21/14

(52) U.S. Cl. CPC H02P 8/38; H02P 21/14

(57) ABSTRACT

A method for detecting a stall condition in a stepper motor includes measuring stepper motor current, computing load angle of the motor, and detecting a stall condition if the load angle is more than 90 degrees.

### CROSS REFERENCE TO RELATED APPLICATIONS

This application claims priority from Indian Patent Application No. 216-21018528, filed May 30, 2016, the contents of which are incorporated in this disclosure by reference in their entirety.

### BACKGROUND

The present invention relates to control of stepper motors. More particularly, the present invention relates to apparatus and method to detect a temporary or permanent stall condition in a stepper motor.

Stepper motors are used for position control and are designed to operate in open loop (no position feedback). Their inherent stepping ability allows for accurate positioning without feedback. One known way to control a stepper motor in open loop is called vector control and is illustrated in FIG. 1. The stepper motor 10 consists of two coils Lₐ (12) and L_{b} (14), which are driven by a stepper motor driver 16. The actual currents Iₐ and I_{b} flowing in the coils Lₐ (12) and L_{b} (14) are measured using conventional current-measuring techniques and are transformed from the stationary domain to calculated currents I_{d} and I_{q} in the d-q domain based on the imposed angle θ using the well-known Park transform as indicated at reference numeral 18. As is known in the art, the imposed angle θ is generated by the “stepper angle” module 20 based on the desired number of steps and speed presented to inputs 22 and 24, respectively.

The current controller 26 operates by computing V_{d} and V_{q} from the calculated currents I_{d} and I_{q}. The reference current I_{q}_{_}_{ref} is always set to 0 and the reference current I_{d}_{_}_{ref} is set based on a maximum load torque value. The voltages V_{d}and V_{q} are then transformed into stationary domain by calculating voltages Vₐ and V_{b} at reference numeral 28 using inverse Park transform. A pulse-width-modulation (PWM) module 30 is used to generate drive signals that impose calculated voltages Vₐ and V_{b} through the stepper motor driver 16. The rotor of the stepper motor moves through command steps at the commanded speed. As indicated above, the “stepper angle” module 20 generates the imposed angle θ based on steps and speed commands set by the user. Each step corresponds to 90 degrees of angle and the rate of change of angle is dependent on the speed. The stepper angle circuit generates angle θ output by integrating the speed input 24 over time. The integration is halted when the angle θ corresponding to the input command steps 22 is reached. The relation between angle θ and the input command steps 22 is given by:

θ=(command_steps*π)/2

The actual motor coil currents are transformed into a rotating reference frame designated d-q at reference numeral 18 using a Park transform based on imposed angle θ according to the equations

I_{d}−Iₐ cos θ+I_{b} sin θ

I_{q}=−I_{q} sin θ+I_{b} *cos θ

The voltages V_{d} and V_{q} are transformed from the d-q reference frame to voltages in the stationary domain at reference numeral 28 by calculating voltages Vₐ and V_{b} using an inverse Park transform based on the angle θ according to the equations

Vₐ−V_{d} cos θ−V_{q} sin ⊖θ

V_{b}=V_{d} sin θ+V_{q} cos θ

The current controller 26 forces the calculated currents I_{d} and I_{q} to follow reference currents I_{d}_{_}_{ref} and I_{q}_{_}_{ref} by calculating V_{d} and V_{q}. A PI controller is a simple and widely used form of controller and is suitable for this purpose.

The PWM module 30 compares the input reference signal with a higher frequency modulator signal and generates a pulsed output whose average value is equivalent to the input reference.

The stepper driver 16 imposes driving voltages on stepper coils Lₐ and L_{b} based on signals from PWM module 26.

When there is a sudden transient in load torque or an abnormal condition that causes the rotor to miss some steps or completely stall, the controller is not aware of the missed steps or stall condition as there is no position feedback. This may lead to a malfunctioning of the position control system or even its complete stoppage. There is therefore a need to detect temporary or permanent stall of a stepper motor for effective position control.

### BRIEF DESCRIPTION OF THE DRAWING FIGURES

The invention will be explained in more detail in the following with reference to embodiments and to the drawing in which are shown:

FIG. 1 is a block diagram of one prior-art method called vector control that is used to control a stepper motor in open loop.

FIG. 2 is a block diagram illustrating apparatus to perform stall detection for a stepper motor in a vector control system that is used to control the stepper motor operating in open loop in accordance with the present invention.

FIG. 3 is a block diagram showing an illustrative embodiment of a stall detection block in the apparatus of FIG. 2.

FIG. 4 is a flow diagram showing an illustrative method for performing stall detection for a stepper motor in a vector control system that is used to control the stepper motor operating in open loop in accordance with the present invention.

### DETAILED DESCRIPTION

Persons of ordinary skill in the art will realize that the following description of the present invention is illustrative only and not in any way limiting. Other embodiments of the invention will readily suggest themselves to such skilled persons.

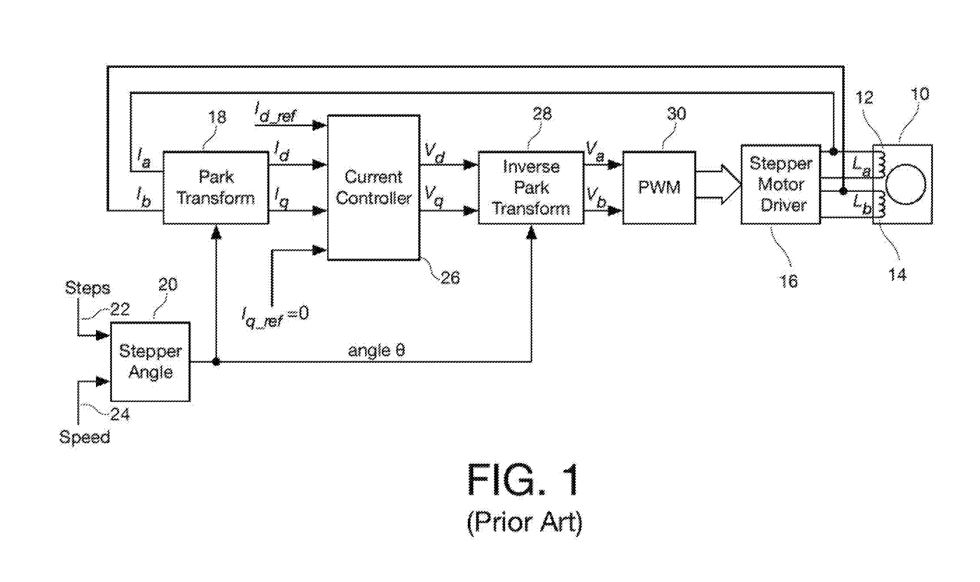

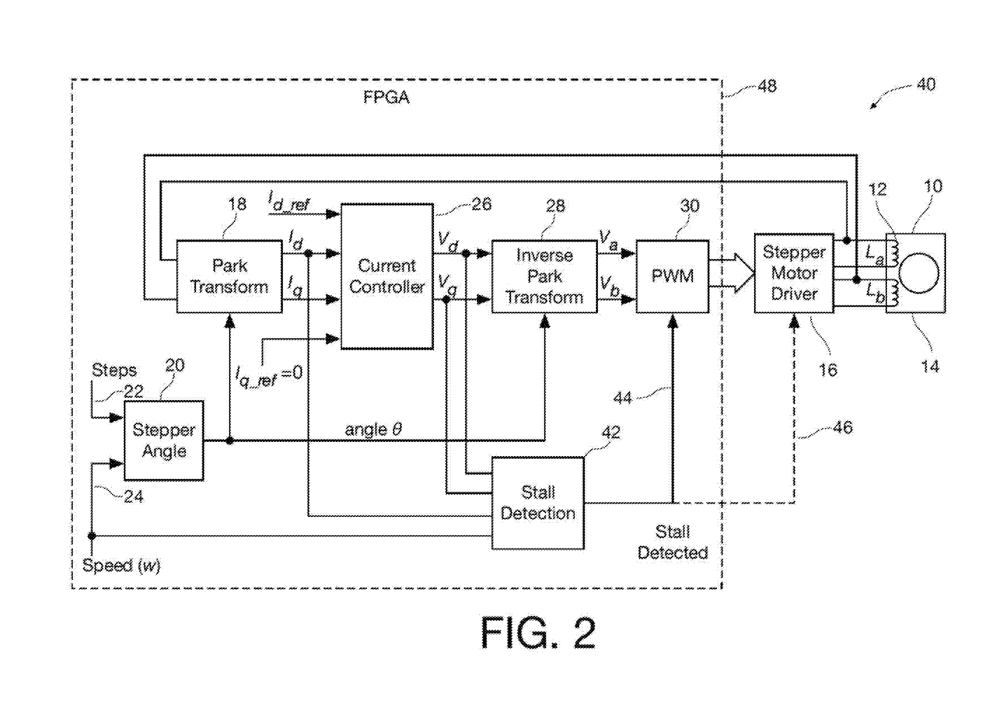

Referring now to FIG. 2, a block diagram illustrates an apparatus 40 configured to perform stall detection for a stepper motor in a vector control system that is used to control the stepper motor operating in open loop in accordance with the present invention. Some of the elements depicted in FIG. 2 are also present in the system shown in FIG. 1. These elements will be referred to in FIG. 2 using the same reference numerals that are used to designate their counterparts in FIG. 1.

As in the system depicted in FIG. 1, the stepper motor 10 consists of two coils Lₐ (12) and L_{b} (14), which are driven by a stepper motor driver 16. The actual currents Iₐ and I_{b} flowing in the coils Lₐ (12) and L_{b} (14) are measured using conventional current-measuring techniques and are transformed from the stationary domain to calculated currents I_{d} and I_{q} in the d-q domain based on the imposed angle θ using the Park transform as indicated at reference numeral 18. As is known in the art, the imposed angle θ is generated by the “stepper angle” module 20 based on the desired number of steps and desired speed presented to inputs 22 and 24, respectively. The stepper angle circuit generates angle θ output by integrating the speed input 24 over time. The integration is halted when the angle θ corresponding to the input command steps 22 is reached. The relation between angle θ and the input command steps 22 is given by:

θ=(command steps *π);/2

The current controller 26 regulates the transformed currents I_{d} and I_{q} by calculating V_{d} and V_{q}. The reference current I_{q ref} is always set to 0 and the reference current I_{d}_{_}_{ref} is set based on a maximum load torque value. The voltages V_{d} and V_{q} are then transformed into calculated voltages Vₐ and V_{b} at reference numeral 28 using inverse Park transform. A pulse-width-modulation (PWM) module 30 is used to generate drive signals that impose voltages calculated Vₐ and V_{b} through the stepper motor driver 16. The rotor of the stepper motor moves through command steps at the commanded speed. The “stepper angle” module 20 generates the imposed angle θ based on steps and speed commands set by the user. Each step corresponds to 90 degrees of angle and the rate of change of angle is dependent on the speed.

The currents Iₐ and I_{b} are transformed into a rotating reference frame designated d-q at reference numeral 18 by calculating currents I, and I_{d} using a Park transform based. on imposed angle θ according to the equations

I_{d}=Iₐ cos θ+I_{b} sin θ

I_{q}=−Iₐ sin θ+I_{b} cosθ

The voltages V_{d} and V_{q} are transformed from the d-q reference frame to voltages in the stationary domain at reference numeral 28 by calculating voltages Vₐ and V_{b} using an inverse Park transform based on the imposed angle θ according to the equations:

Vₐ=V_{d} cos θ−V_{q} sin ⊖θ

V_{b}=V_{d} sin θ+V_{q} Cos θ

The current controller 22 forces the currents I_{d} and I_{q} to follow reference currents I_{d}_{_}_{ref} and I_{q}_{_{—ref}} by calculating V_{d} and V_{q}. A PI controller is a simple and widely used form of controller and is suitable for this purpose.

The PWM module 30 compares the input reference signal with a higher frequency modulator signal and generates a pulsed output whose average value is equivalent to the input reference.

The stepper driver 16 imposes driving voltages on stepper coils Lₐ and L_{b} based on signals from PWM module 30.

According to the present invention, the load angle is computed based on measured voltages and currents and is compared against a threshold value to detect rotor stall in stall detection module 42. The voltage equations of the stepper motor in d-q domain are:

Vd=I_{d}R−I_{q}Lw+KNw sin δ eq(1)

Vq=I_{q}R+I_{d}LNw+Nwcos δ eq(2)

Where:

N=Number of teeth in the stepper motor

w=Rotor speed

R=Resistance of the stepper motor coils

L=Inductance of the stepper motor coils

K=Back-emf constant of the stepper motor

δ=Load angle which is the angle between rotor magnetic field and stator current

For stepper motor control, I_{q} is forced to zero, so the above equations can be simplified as:

KNw sin δ=V_{d}−I_{d}R eq(3)

KNw cos δ=V_{q}−I_{d}LNw eq(4)

The load angle δ can be found from above equations using inverse tangent through a look up table or a CORDIC algorithm

δ=tan⁻¹ [symbol] KNw sin δ/KNw cos δ [symbol] eq(5)

Module 42 solves eq. (3), eq. (4), and eq, (5), and makes a stall-detected decision based on the solutions,

The value of δ computed from the above equation is used to detect a stalled condition. If the angle δ is more than 90 degrees for positive speed or less than −90 degrees for negative speed, the stall condition signal is asserted. The stall condition signal can be used to disable the PWM 30 shown in solid line 44 or to disable the stepper motor driver 16 as shown by dashed line 46 in FIG. 2.

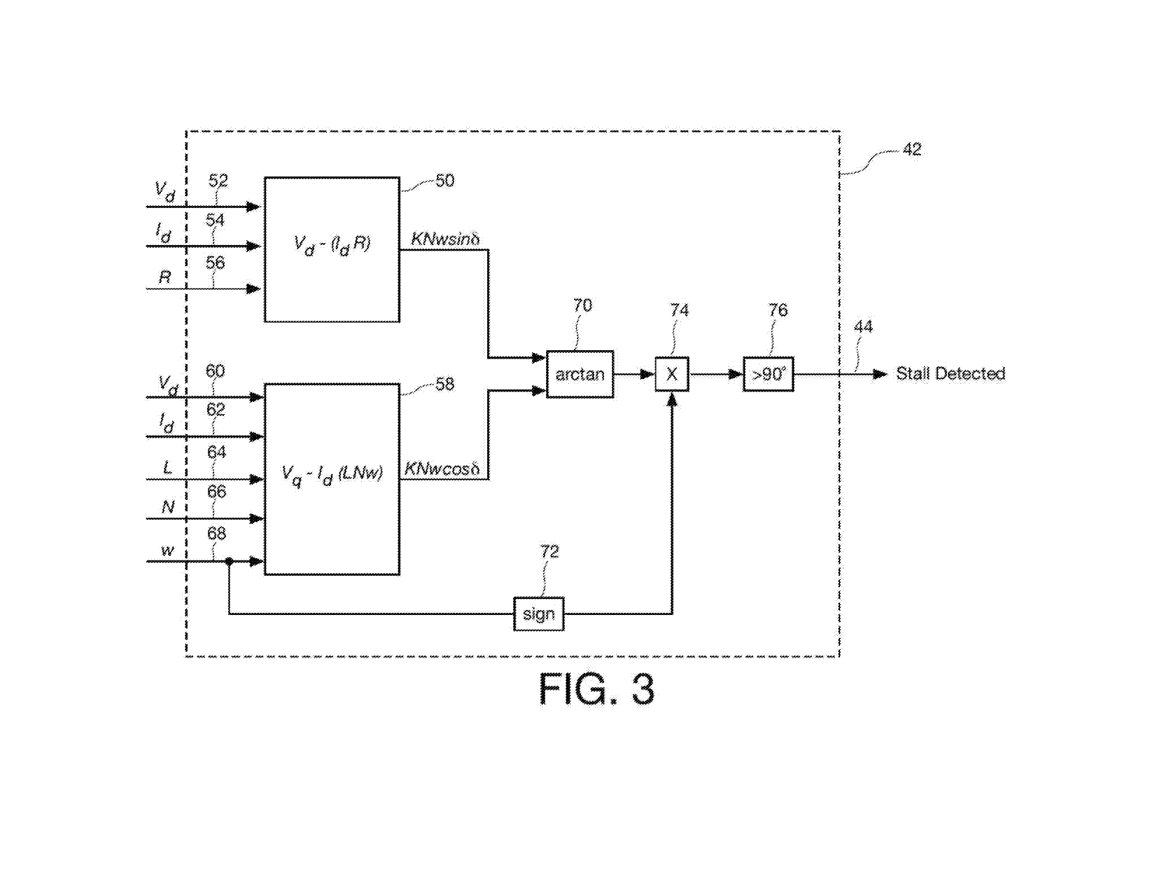

Referring now to FIG. 3, a block diagram shows an illustrative embodiment of a stall detection block 42 in the apparatus of FIG. 2. The stall detection module 42 computes the value of load angle and detects stall condition as shown in FIG. 3. Equations (3) and (4) are implemented to find the Cosine and Sine term and an inverse tangent is used to find the load angle The sign of the speed is multiplied with the load angle δ to make it always positive. Stall condition is asserted if the load angle exceeds 90°. The proposed apparatus and method of the present invention is easy to implement in a field programmable gate array (FPGA) 48 because of the simplicity of the equations involved. All of the elements of the apparatus of FIG. 2 typically except for the stepper motor driver 16 and the stepper motor 10 can be contained within the FPGA 48. Persons of ordinary skill in the art will recognize that the present invention is not limited to the use of FPGA devices, but is also applicable to micro-controller or DSP solutions. In the FPGA case, computational resources are reduced and in the micro-controller or DSP case, the computational time is reduced.

The calculated voltage and current V_{d}, I_{d}, and the resistance R of the stepper coils are presented to sine term calculator 50 on lines 52, 54, and 56, respectively. The value R is a constant characteristic of the stepper motor 10 being controlled. The terms V_{d}, I_{d}, L, N, and w are presented to cosine term calculator 58 on lines 60, 62, 64, 66, and 68, respectively, with L and N being supplied from a register value set during initial setup or design. The values L and N are constants characteristic of the stepper motor 10 being controlled, and w is the desired speed command 24 in FIG. 2. As will be appreciated by persons of ordinary skill in the art, sine term calculator 50 and cosine term calculator 58 can easily be configured from arithmetic circuits that are readily implementable in the FPGA 48.

The terms KNwsin δ and KMvcosδ calculated by sine term calculator 50 and cosine term calculator 58 are presented to arctan calculator 70. As will be appreciated by persons of ordinary skill in the art, arctan calculator 70 can easily be configured from arithmetic circuits that are readily implementable in the FPGA 48.

The w term representing rotor speed on line 68 can be either a positive or negative number depending on the direction of desired rotation of the stepper motor 10. The sign block 72 determines the sign of w. If the sign is positive, the sign block 72 outputs a value of 1. If the sign is negative, the sign block 72 outputs a value of −1.

In multiplier 74, the arctan value angle δ calculated from arctan calculator 70 is multiplied by the output of the sign block 72. At decision block 76, it is determined if the angle δ is greater than 90°. If angle δ is greater than 90°, a stall condition is indicated and a stall condition signal is output on line 44.

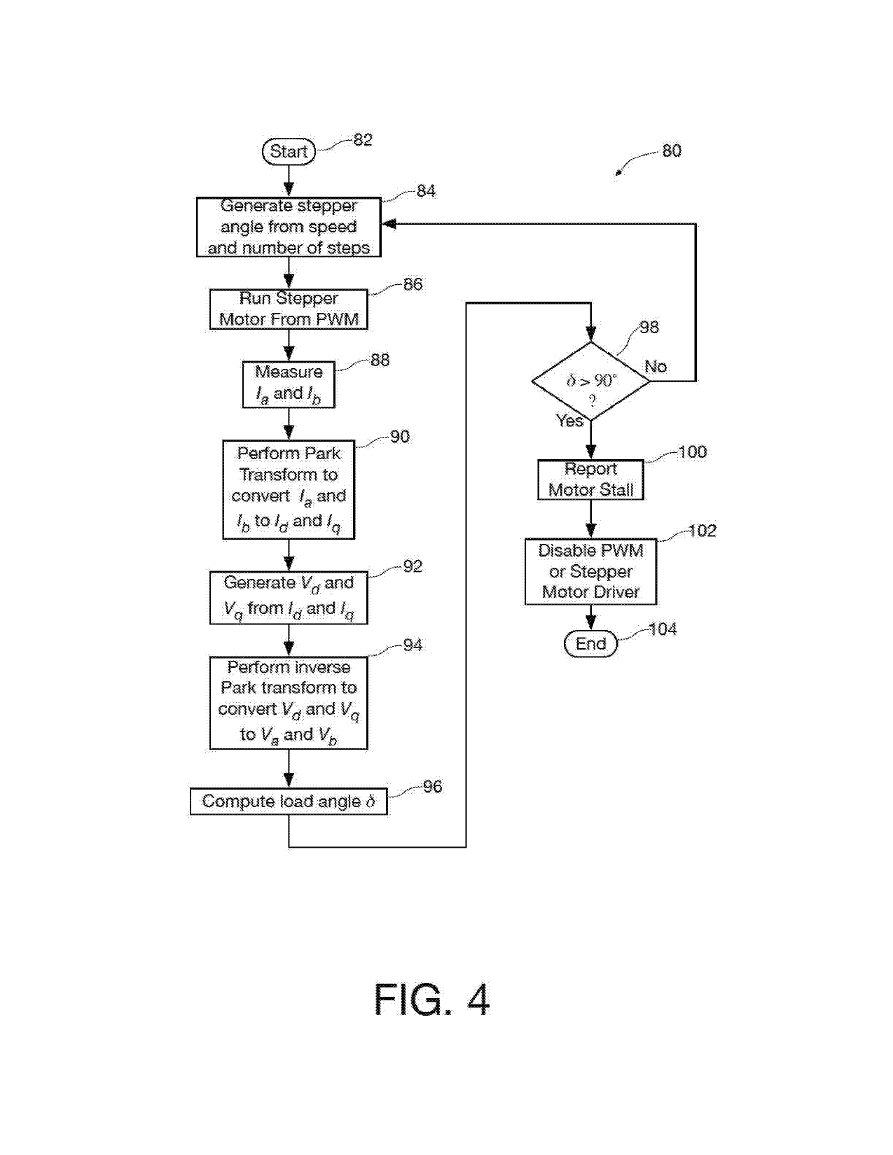

Referring now to FIG. 4, a flow diagram shows an illustrative method 80 for performing stall detection for a stepper motor in a vector control system that is used to control the stepper motor operating in open loop in accordance with the present invention. The method starts at reference numeral 82.

At reference numeral 84, a stepper angle is generated from the speed w and number of steps input by the user. At reference numeral 86, the stepper motor is run from the PWM 30. At reference numeral 88 currents Iₐ and I_{b} are measured and converted to values. At reference numeral 90, the Park transform is used to convert the values of the measured currents tₐ and to values id and I_{q}. At reference numeral 92, the voltage values V_{d} and V_{q} are generated from the current values I_{d} and I_{q}. At reference numeral 94, an inverse Park transform is performed to convert the voltage values V_{d} and I^{q} to voltage values Vₐ and V_{b}. At reference numeral 96, the load angle δ is calculated. At reference numeral 98, it is determined whether the load angle δ is greater than 90°. If the load angle δ is not greater than 90° the method returns to reference numeral 84. If the load angle 6 is greater than 90°, a stall condition is reported at reference numeral 100 and the method proceeds to reference numeral 102, where the motor is stopped by disabling either the PWM 30 or the stepper motor driver 16. The method then ends at reference numeral 104.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for detecting a stall condition in a stepper motor comprising:
measuring stepper motor current;
computing a load angle of the motor; and
detecting a stall condition if the load angle is more than 90 degrees.

2. The method of claim I wherein the load angle is computed using motor voltage, current, resistance, and inductance.

3. The method of claim 1, further comprising disabling one or both of the pulse width modulator and the stepper motor driver.

4. A method for operating a stepper motor comprising:
generating a stepper angle from the speed and number of steps input by the user;
running the stepper motor using signals from a pulse width modulator through a stepper motor driver;
measuring currents from coils in the stepper motor;
converting the measured currents to currents in a d-q domain;
calculating voltage values in the d-q domain from the currents in the d-q domain;
converting the voltages in the d-q-domain to voltage values in a stationary domain;
calculating a load angle of the stepper motor;
determining whether the load angle is greater than 90°;
if the load angle is not greater than 90°, continuing to run the stepper motor; and
if the load angle δ is greater than 90°, reporting a stall condition.

5. The method of claim 4 wherein converting the measured currents to currents in a d-q domain comprises converting the measured currents to currents in a d-q domain using a Park transform. 6. The method of claim 4 wherein converting the voltages in the d-q-domain to voltages in the time domain comprises converting the voltages in the d-q-domain to voltages in the time domain using an inverse Park transform.

7. The method of claim 4 further comprising stopping the stepper motor by disabling one or both of the pulse width modulator and the stepper motor driver.

8. An apparatus for controlling a stepper motor, the apparatus comprising:
a stepper motor driven from a stepper motor driver circuit;
a stepper angle generator circuit coupled to a user step input and user speed input, the stepper angle generator circuit having an output;
current sensing and measuring circuits to measure currents flowing in coils of the stepper motor;
a Park transform circuit coupled to the current sensing and measuring circuits and to the output of the stepper angle generator circuit to convert the measured currents to currents in a d-q domain;
a current controller coupled to the Output of the current controller to generate voltages in the d-q domain from the currents in the d-q domain and reference currents in the d-q domain and a time domain;
an inverse Park transform circuit coupled to the output of the current controller and to the output of the stepper angle generator circuit to transform the voltages in the d-q-domain to voltages in the time domain;
a pulse width modulator circuit driven from the inverse Park transform. circuit; and.
a stall detector circuit driven from the Park transform circuit and the current controller circuit to compute a load angle of the stepper motor and to generate a stall-detected signal coupled to at least one of the pulse width modulator circuit and the stepper motor driver circuit to stop the stepper motor if the load angle is greater than 90°.
